(19) United States
(12) Patent Application Publication
(10) Pub. No.: US 2026/0085577 A1
(43) Pub. Date: Mar. 26, 2026

(54) PREFABRICATED SHED DOORS AND METHODS OF MANUFACTURE

(71) Applicant: Owen Woodruff Bunker, II, Denver, CO (US)

(72) Inventor: Owen Woodruff Bunker, II, Denver, CO (US)

(21) Appl. No.: 19/334,514

(22) Filed: Sep. 19, 2025

Related U.S. Application Data
(60) Provisional application No. 63/697,209, filed on Sep. 20, 2024.

(51) Int. Cl. E06B 5/02; E06B 3/06

(52) U.S. Cl. CPC E06B 5/02; E06B 3/06

(57) ABSTRACT

Shed doors may include a panel, a trim coupled with the panel, and a frame coupled with a rear surface of the panel. Portions of the panel contacting the trim may be planarized and the trim may be planarized such that exposed faces of the trim are coplanar when coupled with a face of the panel. The frame may be planarized such that exposed faces of the frame are coplanar when coupled with the panel.

### CROSS-REFERENCE TO RELATED APPLICATIONS

This application claims priority to and the benefit of U.S. Application No. 63/697,209, entitled “PREFABRICATED SHED DOORS AND METHODS OF MANUFACTURE,” filed Sep. 20, 2024, the contents of which are hereby incorporated by reference in their entirety.

### BACKGROUND OF THE INVENTION

Many shed doors are produced from composite wood materials, such as plywood, oriented strand board (OSB), particle board, medium density fiberboard, and the like. Due to the manufacturing processes of such materials, doors produced from composite wood materials often have thicknesses that noticeably vary along a length of the door, causing uneven fits and ultimately becoming damaged and/or difficult to properly close. These effects are amplified with each additional layer of material used to produce the door. Additionally, the interior and exterior sides of the doors are often exposed to different temperatures and/or humidity levels, as the door may trap heat and/or moisture within the shed, creating temperature and/or humidity differences between the interior of the shed and the outside environment. These differences may cause one side of the door to expand and/or contract at a different rate than the other side, leading to bowing. When a door bows such that the top and/or bottom of the door bends away from the shed, the door is no longer capable of fully sealing the interior of the shed from the elements. Therefore, improvements in shed doors are desired.

### BRIEF SUMMARY OF THE INVENTION

Shed doors may include a panel, a trim coupled with the panel, and a frame coupled with a rear surface of the panel. Portions of the panel contacting the trim may be planarized and the trim may be planarized such that exposed faces of the trim are coplanar when coupled with a face of the panel. The frame may be planarized such that exposed faces of the frame are coplanar when coupled with the panel.

In some embodiments, the trim may be coupled with a front face of the panel. The trim may be coupled with the rear face of the panel. The trim may be disposed between the frame and the panel. The shed doors may include a rear sheathing coupled with the frame. A front surface of one or both of the panel and the trim may include one or more planarized regions for receiving hinges. The one or more planarized regions may be sized and shaped to match interface portions of the hinges.

Some embodiments of the present technology may encompass methods of manufacturing a shed door. The methods may include providing a panel, planarizing a portion of the panel, and applying trim to the portion of the panel. The methods may include planarizing a frame, applying the frame to a rear surface of the panel, and compressing the panel, the trim, and the frame with an adhesive to form the shed door.

In some embodiments, the trim may be applied to a front surface of the panel. The trim may be applied to the rear surface of the panel. The methods may include applying the adhesive between the trim and the panel. The methods may include applying the adhesive between the frame and one or both of the trim and the panel. The methods may include planarizing one or more regions on one or both of the panel and the trim to form hinge-receiving locations. The methods may include drilling one or more holes in the one or more regions to accommodate one or more fasteners. The methods may include forming one or more holes for one or both of a door handle and a lock. The methods may include planarizing a portion of one or both of the trim and the panel to form a graphic. The methods may include applying one or more spacers to one or more edges of the shed door.

### BRIEF DESCRIPTION OF THE DRAWINGS

A further understanding of the nature and advantages of the disclosed technology may be realized by reference to the remaining portions of the specification and the drawings.

FIGS. 1-1B illustrate a shed door according to embodiments of the present invention.

FIGS. 2-2B illustrate a shed door according to embodiments of the present invention.

FIGS. 3-3B illustrate a door assembly according to embodiments of the present invention.

FIG. 4 is a flowchart of a method for manufacturing a shed door according to embodiments of the present invention.

FIG. 5 is a flowchart of a method for manufacturing a shed door according to embodiments of the present invention.

FIG. 6 is a flowchart of a method for installing a shed door according to embodiments of the present invention.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to doors for sheds and/or other exterior utility buildings. In particular, embodiments are directed to shed doors that are formed partially or entirely from a composite wood material. The doors described herein may be formed with very tight tolerances that ensure that a thickness of the door is uniform along a length of the door. This enables the doors to close properly and uniformly about the door opening and to provide a clean aesthetic. In some embodiments, the doors may be fabricated to include an bowed profile, with a top and/or bottom of the door bowing toward the shed. This may ensure that any temperature and/or humidity differential between the interior of the shed and the outside environment do not cause the top or bottom of the door to bow away from the shed, but instead just reduce the bowing toward the shed or straighten the door, thereby still enabling the door to properly close and seal the door opening. Some embodiments may also include one or more features that help prevent water from sitting atop the door, which could otherwise cause warping or other damage to the door.

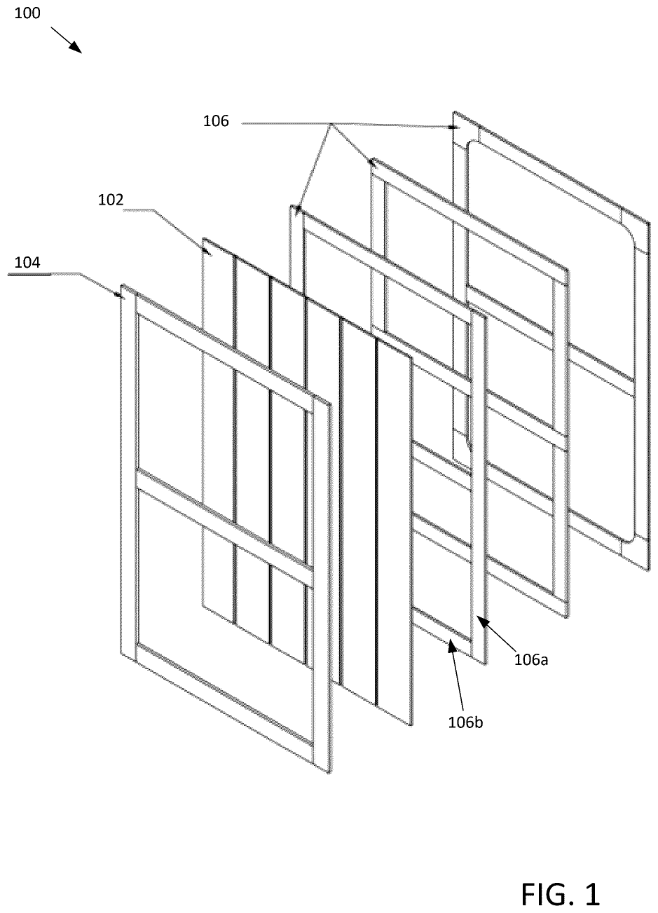

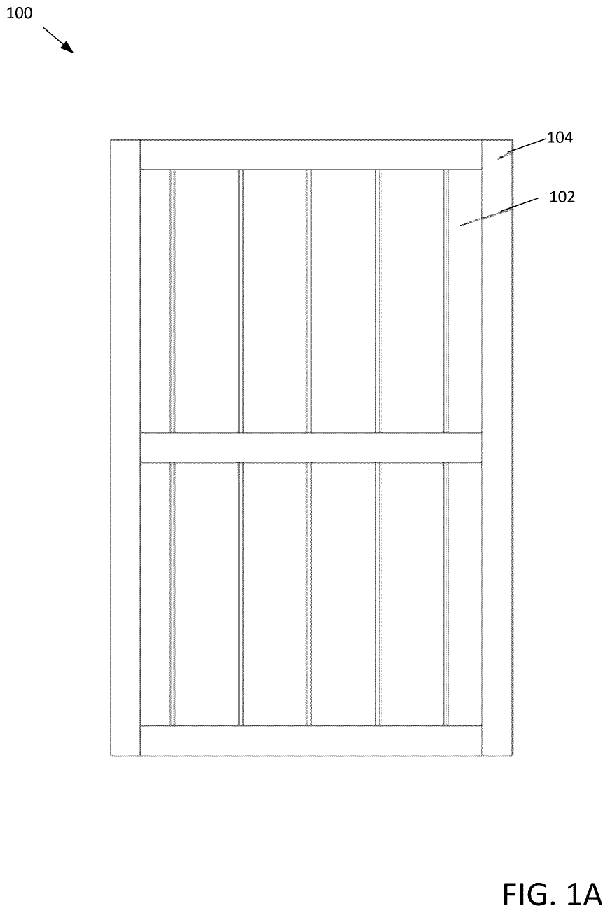

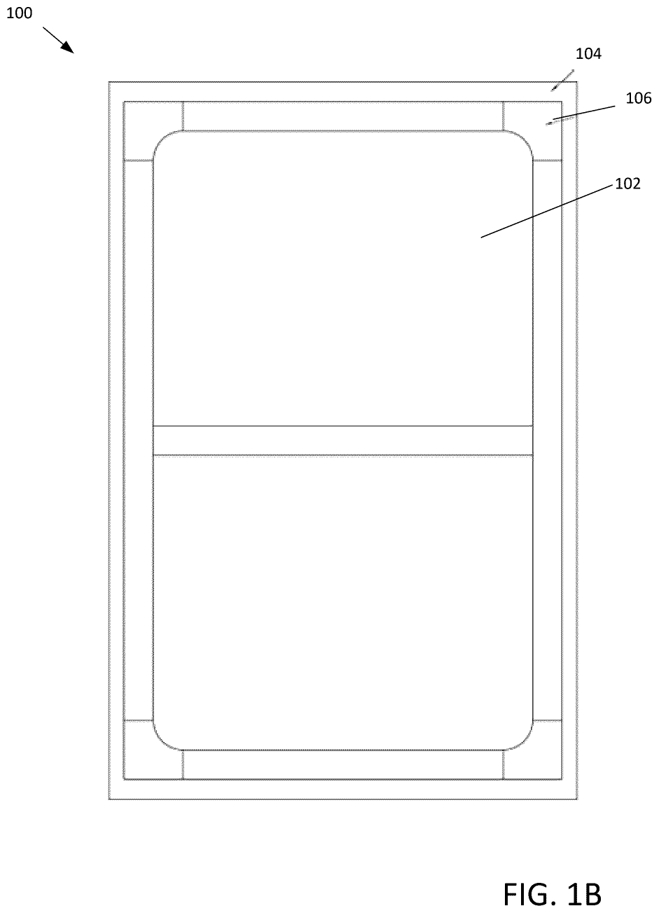

Turning now to FIGS. 1-1B, an embodiment of a shed door 100 is illustrated. Shed door 100. Shed door 100 may include a panel 102, which may be formed from a same material as a siding of the shed in some embodiments. For example, the panel 102 may be formed from a composite wood material such as, but not limited to, plywood, oriented strand board (OSB), particle board, and/or medium density fiberboard. The panel 102 may define the outer dimensions of the shed door 100 in some embodiments and may be any dimensions to meet the needs of a particular application. In the illustrated embodiment, the shed door 100 includes trim 104, which may extend around all or a portion of the perimeter of the panel 102. The trim 104 may be formed from a same or similar material as the panel 102 or may be formed from an entirely different material in some embodiments. As illustrated, the trim 104 forms a border that extends around an entire perimeter of the panel 102, although in other embodiments only one, two, or three edges of the panel 102 may include pieces of the trim 104. Portions of the panel 102 on which the trim 104 is positioned may be sanded and/or otherwise planarized to remove all grain texture formed on the exterior surface of the panel 102. This may ensure that the thickness of the panel 102 is uniform about a border of the panel 102. Similarly, a rear surface of each piece of the trim 104 may be sanded and/or otherwise planarized to a uniform thickness. The combination of the planarized front perimeter of the panel 102 and the planarized rear of the trim 104 may ensure that edges of pieces of the trim 104 that abut one another sit flush relative to each other once mounted to the panel 102.

The shed door 100 may include a frame 106 on a rear surface of the panel 102. The frame 106 may include any number of members that may help strengthen and reinforce the shed door 100. For example, the frame 106 may include one or more vertical frame members 106a that extend at least part of distance from a bottom of the panel 102 to a top of the panel 102, one or more horizontal members 106b that extend at least part of distance from one lateral side of the panel 102 to the other lateral side of the panel 102, and/or one or more diagonal members (not shown). In some embodiments, each frame member is connected to and/or contacts another frame member, while in other embodiments one or more of the frame members may be isolated from other frame members. The frame 106 may be aligned with and extend to the peripheral edges of the panel 102 and/or may offset inward from the peripheral edges of the panel 102. Each frame member may include one or more pieces of material that may be joined to form the respective frame member and/or the frame 106.

In the illustrated embodiment, the frame 106 includes two vertical frame members 106a that are spaced apart along a width of the panel 102 and three horizontal frame members 106b that are spaced apart along a height of the panel 102. For example, one of the vertical frame members 106a may be disposed at or near a first lateral edge of the panel 102 and the other vertical frame 106a may be disposed at or near a second, opposite lateral edge of the panel 102. A first horizontal frame member 106b may be at or proximate a top edge of the panel 102, a second horizontal frame member 106b may be at or proximate a bottom edge of the panel 102, and a third horizontal frame member 106b may be positioned at or proximate a center of the panel 102, such as proximate a height of a door handle or other feature of the shed door 100. The frame 106 may include any number of frame members with some of the frame members serving as reinforcements for various features of the shed door 100 in some embodiments. For example, the shed door 100 may include one or more frame members proximate hinges, handles, windows, and/or other features of the shed door 100.

The frame 106 may be formed from one or more layers of material. The material may be or may include composite wood materials, polymeric materials, fiberglass, metals, and/or other rigid materials. In a particular embodiment, the frame 106 may include a composite wood material similar to that used to form the panel 102 and/or the trim 104. The frame 106 may be formed from any number of layers of material, which may be the same or different thicknesses. For example, the frame 106 may include one or more layers, two or more layers, three or more layers, four or more layers, five or more layers, or more. In some embodiments, such as those in which adjacent frame members are in contact with one another, ends of pieces of frame members (or pieces thereof) may overlap from one layer of material to the next. Such an overlap design may create stronger joints and prevent thick seams from being formed that extend through multiple layers of the frame 106. Additionally, once joined, the overlapping frame members may act as a single, unitary frame 106 that offers increased strength. In some embodiments, one or more layers of the frame 106 may include gusset members at corners or other locations where a vertical frame member 106a meets a horizontal frame member 106b. The gusset members may strengthen the corners and provide a clean aesthetic, such as by including rounded interior corner surfaces.

Each piece of the frame 106 (or layer of the frame 106) may be sanded and/or otherwise planarized to a uniform thickness. This ensures that the frame 106 may have a uniform thickness across a surface area of the frame 106. The frame 106, trim 104, and panel 102 may be secured together using an adhesive, such as (but not limited to) a water activated adhesive to form the shed door 100. Additionally, the shed door 100 may be compressed together via a press. The combination of planarized components, adhesive, and compression enables the shed door 100 to function as an essentially monolithic component, as the planarization and compression significantly increase the surface contact area between the various components as compared to conventional shed doors. For example, in conventional shed doors, the trim is applied directly to the front surface of the panel without planarizing any of the panel. This results in the rear side of the trim contacting the wood grain of the panel, which significantly reduces the contact area, and subsequently bond strength between the trim and the panel. Additionally, by using compression and an adhesive to bond the components of the shed door 100 together, embodiments may eliminate the need for fasteners and/or liquid nails to hold the components together, although fasteners and/or liquid nails may be present in some embodiments.

In some embodiments, the shed door 100 may include rear sheathing (not shown), which may provide a more finished appearance to the interior surface of the shed door 100. The rear sheathing may be formed from a panel, such as the panel 102 to create a finished, wood grain finish in some embodiments. In some embodiments, the rear sheathing may be formed from a different material than the panel 102, such as (but not limited to) an unfinished wood composite material. In some embodiments, the rear sheathing may have the same dimensions as the panel 102 and may create a fully finished appearance, while in other embodiments the rear sheathing may be smaller than the panel 102. For example, in some embodiments in which the frame 106 is inset from the peripheral edges of the panel 102, the rear sheathing may also be inset from the peripheral edges of the panel 102 by the same or different dimensions as the frame 106. In some embodiments that include rear sheathing, insulation, such as foam insulation, fiberglass insulation, and/or other insulation may be provided within a cavity formed between the panel 102 and the rear sheathing.

In some embodiments, the shed door 100 may be formed with a bowed profile. For example, the top and/or bottom of the shed door 100 may be pre-formed such that the top and/or bottom of the shed door 100 curves toward a rear of the shed door 100 (e.g., toward the door opening of the shed. The curvature may be between 0.05 inches and 0.5 inches from a center of the shed door 100 to a top and/or bottom edge of the shed door 100 in some embodiments. Such curvature may ensure that temperature and/or humidity differentials between the interior of the shed and the outside environment do not cause the shed door 100 to bow in the opposite direction, which would impair the shed door's ability to fully close and seal the interior of the shed. Even with the pre-bowed shape, the shed door 100 will be able to fully close, as the latch and hinges enable the center region of the shed door 100 (which protrudes outward relative to the top and/or bottom edge) to stay bent to straighten the shed door 100 when a user applies a closing force that latches the shed door 100 in a closed position.

The shed door 100 may include a number of additional features. For example, the shed door 100 may include hinges, locks, handles, signage, and/or other features that may be adhered, fastened, and/or or other components that may be attached to one or more surfaces of the shed door 100. In some embodiments, a surface of the shed door 100 on which such components are affixed may be planarized and formed to a uniform thickness prior to attaching the components. As just one example, a portion of the panel 102 and/or the trim 104 may be planarized to remove a woodgrain texture to receive one or more hinges that are used to attach the shed door 100 to the shed. This may ensure that substantially all (e.g., at least 75%, at least 80%, at least 90%, at least 95%, or more) of a surface area of each hinge sits flush against the planarized surface of the panel 102 and/or the trim 104, rather than having small gaps throughout due to the presence of wood grain of the panel 102 and/or the trim 104. Additionally, such techniques may ensure that each hinge is substantially coplanar with one another once attached to the door panel 100. In some embodiments, the planarized portion of the panel 102 and/or the trim 104 may be sized and/or shaped to match a size and/or shape of the respective component. In embodiments in which one or more of the components are attached via fasteners, one or more pilot holes may be predrilled or otherwise formed in the shed door 100. The planarization and/or drilling may be performed using precision fabrication techniques, such as through the use of a computer numerical control (CNC) tool, which may ensure that the components are properly aligned on the shed door 100, thereby eliminating the likelihood of misalignment that may otherwise occur due to human error.

In some embodiments, one or more horizontal surfaces of the shed door 100 on an exterior side of the shed door 100 may be tapered to facilitate better drainage of water. For example, upper surfaces of horizontal surfaces of the trim 104 may be tapered downward and away from the panel 102 such that any water or other liquid is directed downward and away from the panel 102.

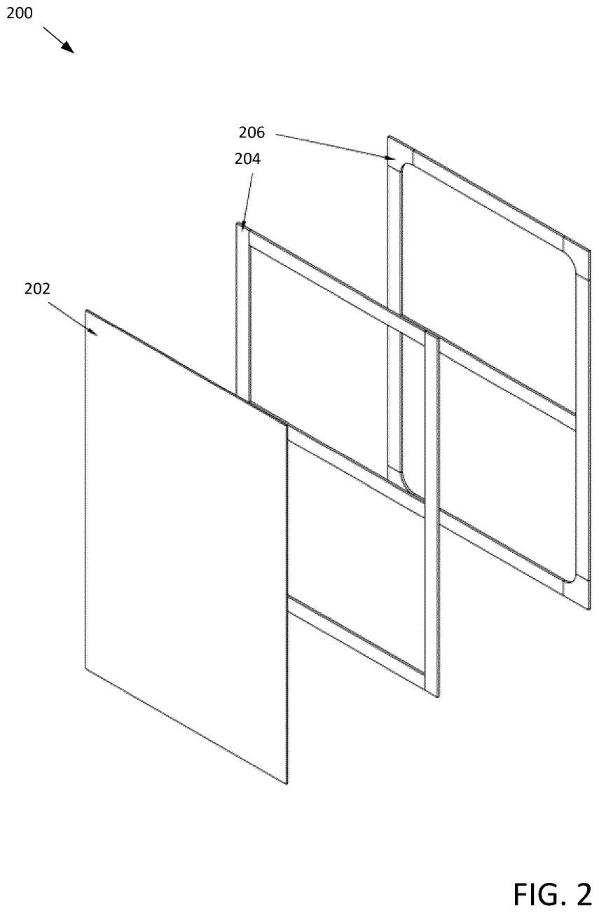

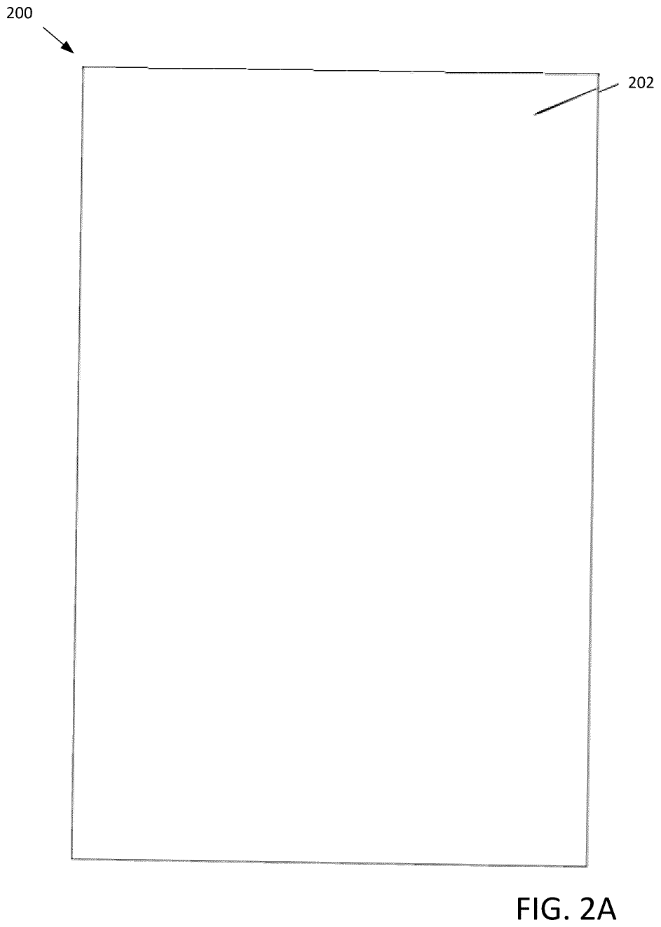

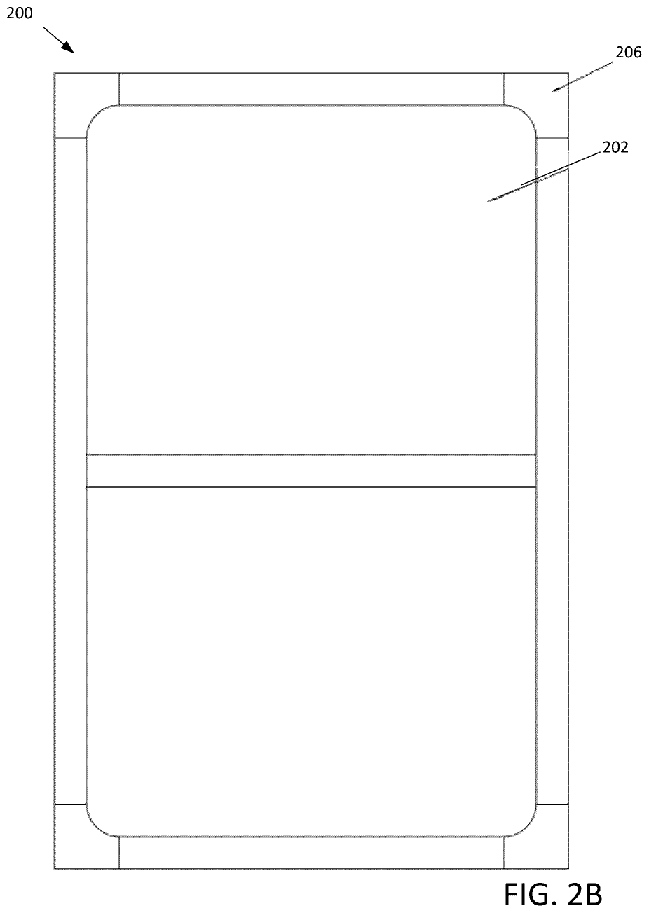

FIGS. 2-2B illustrate an embodiment of a shed door 200. Shed door 200 may be similar to shed door 100 and may include any feature described in relation to shed door 100. For example, shed door 200 may include a panel 202, which may be similar to the panel 102 described above. In some embodiments, shed door 200 may include trim 204, which may be similar to the trim 104, however the trim 204 is positioned on a rear surface of the panel 202 rather than a front surface of the panel 202 as done in shed door 100. In such embodiments, the trim 204 (or other material) may be included to provide additional thickness and strength to the shed door 200. This may help support additional components of the shed door 200, such as hinges, handles, locks, and the like. As illustrated, the trim 204 forms a border that extends around an entire perimeter of a rear surface of the panel 202, although in other embodiments only one, two, or three edges of the panel 202 may include pieces of the trim 204. Portions of the panel 202 on which the trim 204 is positioned may be sanded and/or otherwise planarized. This may ensure that the thickness of the panel 202 is uniform about a border of the panel 202. Similarly, a front surface of each piece of the trim 204 may be sanded and/or otherwise planarized to a uniform thickness. The combination of the planarized rear perimeter of the panel 202 and the planarized front of the trim 204 may ensure that edges of pieces of the trim 204 that abut one another sit flush relative to each other once mounted to the panel 202.

The shed door 200 may include a frame 206 on a rear surface of the trim 204 (or panel 202 where the trim 204 is omitted), which may be similar to frame 106. The frame 206 may be formed from any number of layers of material, which may be the same or different thicknesses. In some embodiments, one or more layers of the frame 206 may include gusset members at corners or other locations where a vertical frame member meets a horizontal frame member. The gusset members may strengthen the corners and provide a clean aesthetic, such as by including rounded interior corner surfaces. Each piece of the frame 206 (or layer of the frame 206) may be sanded and/or otherwise planarized to a uniform thickness. This ensures that the frame 206 may have a uniform thickness across a surface area of the frame 206. The frame 206, trim 204, and panel 202 may be secured together using an adhesive to form the shed door 200. Additionally, the shed door 200 may be compressed together via a press. The shed door 200 may include rear sheathing (not shown), which may have the same dimensions as the panel 202 and may create a fully finished appearance or may be smaller than the panel 202.

In some embodiments, the shed door 200 may be formed with a bowed profile. For example, the top and/or bottom of the shed door 200 may be pre-formed such that the top and/or bottom of the shed door 200 curves toward a rear of the shed door 200 (e.g., toward the door opening of the shed. The curvature may be between 0.05 inches and 0.5 inches from a center of the shed door 200 to a top and/or bottom edge of the shed door 200 in some embodiments. The shed door 200 may include a number of additional features. For example, the shed door 200 may include hinges, locks, handles, signage, and/or other features that may be adhered, fastened, and/or or other components that may be attached to one or more surfaces of the shed door 200. In some embodiments, a surface of the shed door 200 on which such components are affixed may be planarized and formed to a uniform thickness prior to attaching the components. In embodiments in which one or more of the components are attached via fasteners, one or more pilot holes may be predrilled or otherwise formed in the shed door 200. The planarization and/or drilling may be performed using precision fabrication techniques, such as through the use of a computer numerical control (CNC) tool, which may ensure that the components are properly aligned on the shed door 200, thereby eliminating the likelihood of misalignment that may otherwise occur due to human error.

While FIGS. 1-2B illustrate shed doors having trim on only one side (e.g., front or rear surface) of the shed door, it will be appreciated that in some embodiments a shed door may include trim on both sides or omit trim entirely.

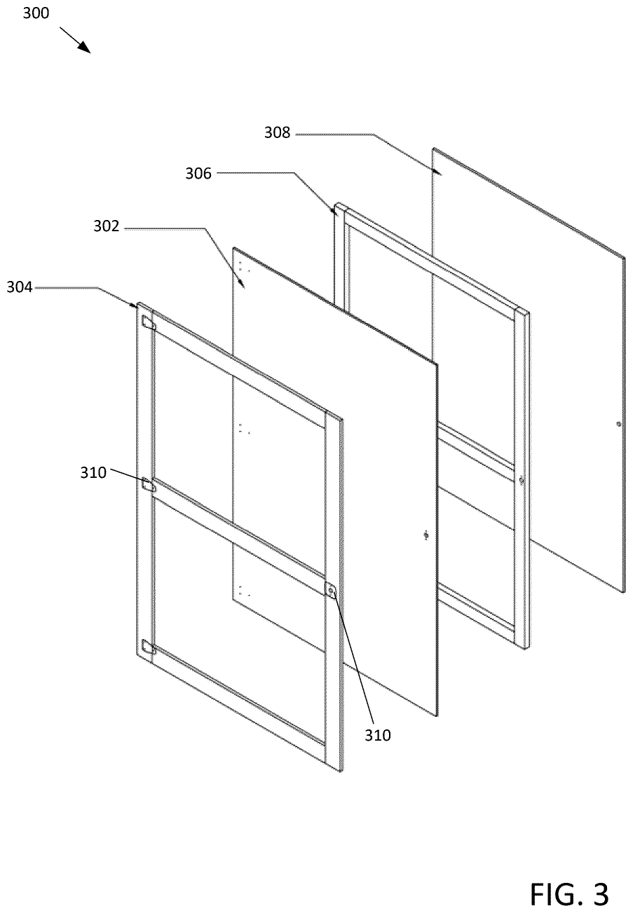

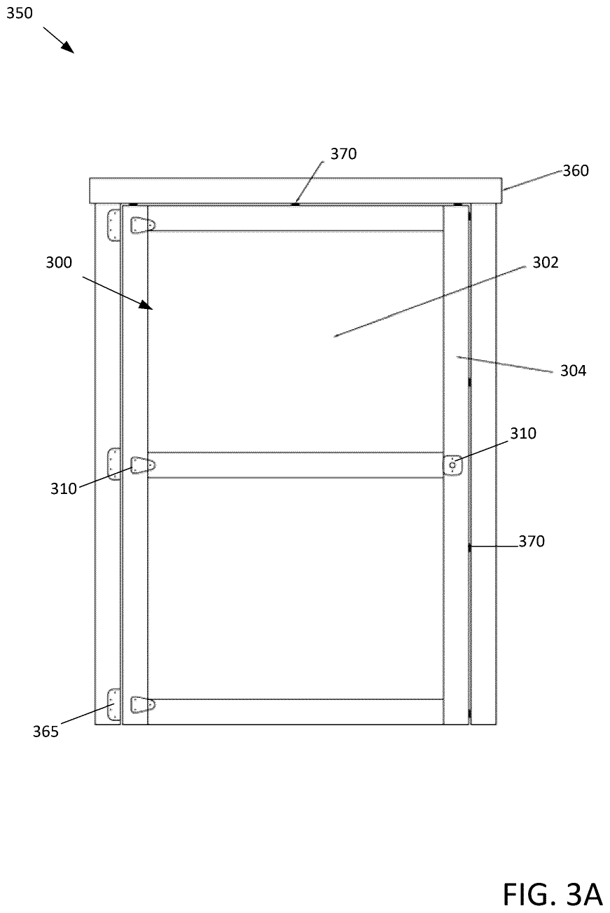

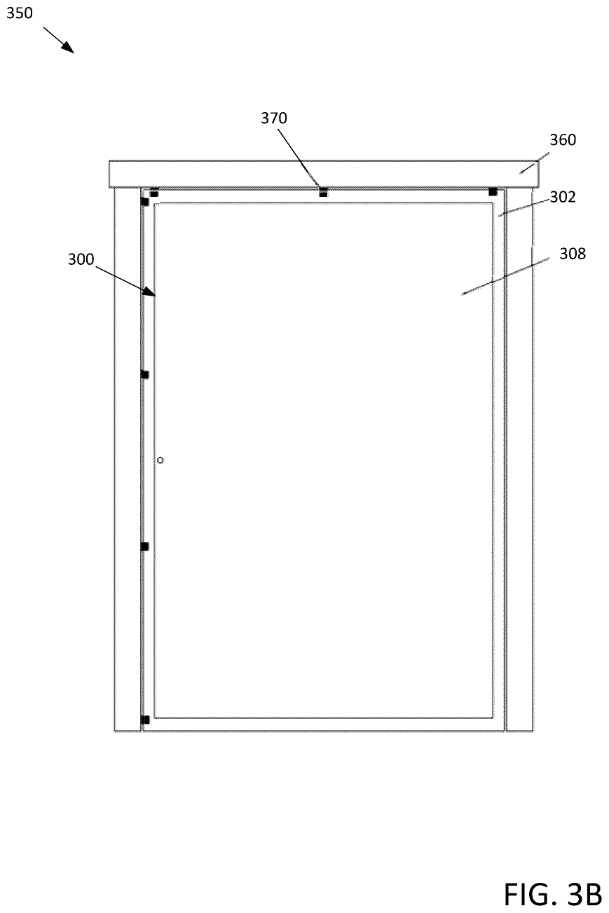

FIGS. 3-3B illustrate an embodiment of a door assembly 350. The door assembly 350 may form a portion of a shed. The door assembly 350 may include a shed door 300, which may be similar to shed doors 100 and 200 and may include any feature described in relation to shed doors 100 and 200. For example, shed door 300 may include a panel 302, which may be similar to the panel 102 described above. In some embodiments, shed door 300 may include trim 304, which may be similar to the trim 104. As illustrated, the trim 304 forms a border that extends around an entire perimeter of a front surface of the panel 302, with an additional horizontal member extending laterally proximate a center of the height of the shed door 300. In other embodiments only one, two, or three edges of the panel 302 may include pieces of the trim 304. Portions of the panel 302 on which the trim 304 is positioned may be sanded and/or otherwise planarized to remove all grain texture formed on the exterior surface of the panel 302. This may ensure that the thickness of the panel 302 is uniform about a border of the panel 302. Similarly, a rear surface of each piece of the trim 304 may be sanded and/or otherwise planarized to a uniform thickness. The combination of the planarized front perimeter of the panel 302 and the planarized rear of the trim 304 may ensure that edges of pieces of the trim 304 that abut one another sit flush relative to each other once mounted to the panel 302.

The shed door 300 may include a frame 306 on a rear surface of the panel 302, which may be similar to frame 106. The frame 306 may be formed from any number of layers of material, which may be the same or different thicknesses. In some embodiments, one or more layers of the frame 306 may include gusset members at corners or other locations where a vertical frame member meets a horizontal frame member. The gusset members may strengthen the corners and provide a clean aesthetic, such as by including rounded interior corner surfaces. Each piece of the frame 306 (or layer of the frame 306) may be sanded and/or otherwise planarized to a uniform thickness. This ensures that the frame 306 may have a uniform thickness across a surface area of the frame 306. The frame 306, trim 304, and panel 302 may be secured together using an adhesive to form the shed door 300. Additionally, the shed door 300 may be compressed together via a press. The shed door 300 may include rear sheathing 308, which may have the same dimensions as the panel 302 and may create a fully finished appearance as shown or may be smaller than the panel 302 in some embodiments.

In some embodiments, the shed door 300 may be formed with a bowed profile. For example, the top and/or bottom of the shed door 300 may be pre-formed such that the top and/or bottom of the shed door 300 curves toward a rear of the shed door 300 (e.g., toward the door opening of the shed. The curvature may be between 0.05 inches and 0.5 inches from a center of the shed door 300 to a top and/or bottom edge of the shed door 300 in some embodiments. The shed door 300 may include a number of additional features. For example, the shed door 300 may include hinges, locks, handles, signage, and/or other features that may be adhered, fastened, and/or or other components that may be attached to one or more surfaces of the shed door 300. In some embodiments, a surface of the shed door 300 on which such components are affixed may be planarized and formed to a uniform thickness prior to attaching the components. For example, as illustrated the shed door 300 includes planarized regions 310 to accommodate hinges and a handle of the shed door 300. In embodiments in which one or more of the components are attached via fasteners, one or more pilot holes may be predrilled or otherwise formed in the shed door 300. The planarization and/or drilling may be performed using precision fabrication techniques, such as through the use of a computer numerical control (CNC) tool, which may ensure that the components are properly aligned on the shed door 300, thereby eliminating the likelihood of misalignment that may otherwise occur due to human error.

As best illustrated in FIG. 3A, the door assembly 350 may include a door trim 360, which may be fastened and/or otherwise secured to the shed. The door trim 360 may extend around a top and/or sides of the shed door 300 and may define a door opening within which the shed door 300 is disposed. In some embodiments, the door trim 360 may include planarized regions 365, such as for hinges used to secure the shed door 300 to the shed. In some embodiments, prior to and/or during installation of the shed door 300, the shed door 300 and/or door trim 360 may include one or more spacers 370. The spacers 370 may be disposed on a top, bottom, side(s), and/or rear-facing surface of the shed door 300 and/or door trim 360 and may be used to properly align the shed door 300 within the door opening of the shed with a desired amount of clearance on each edge of the shed door 300. Spacers 370 on rear-facing surfaces of the shed door 300 may properly set the depth of the shed door 300 within the door opening. The use of the spacers 370 may eliminate and/or reduce alignment errors that may be otherwise attributable to human error. Each spacer 370 may be formed from a polymeric material, wood, and/or other material. The spacer 370 may be removed after the shed door 300 has been installed within the door opening (e.g., after the hinges have been attached to the shed door 300 and the door frame/door trim 360.

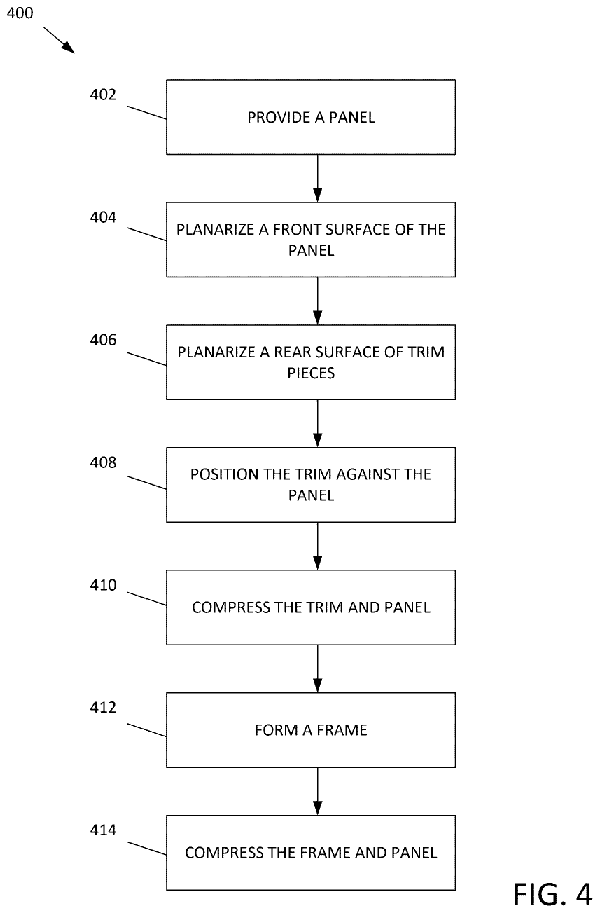

FIG. 4 is a flowchart illustrating a process 400 of manufacturing a shed door with trim on a front surface (such as described in relation to shed doors 100 and 300). Process 400 may be used to manufacture shed doors 100, 200, and 300 described herein, as well as other shed doors. Process 400 may include additional steps and/or omit certain steps in various embodiments. Process 400 may begin at operation 402 by providing a panel of a desired size. In some embodiments, the panel (such as panel 102, 202, or 302) may be prefabricated to a desired size. In other embodiments, the panel may be trimmed to a desired size, which may match the final outer dimensions of the completed shed door. Once the panel has been properly sized, portions of a front surface of the panel where trim may be affixed may be sanded and/or otherwise planarized to remove a wood grain texture at operation 404. For example, a CNC tool may be used to planarize a border and/or other region about the panel to remove the wood grain and prepare a fully planar receiving surface for the trim. While a CNC tool may provide the most precise planarization, other techniques such as hand sanders/planers, power sanders/planers, and/or other techniques may be used to planarize the surface of the panel. Planarizing the surface may not only improve the contact and adhesion between the panel and trim but may also ensure that the faces of each trim piece are substantially planar. This may not be possible without planarizing the panel, as the thickness of panels typically varies by as much as 0.125 inches or more across the length of the panel prior to planarizing due to the manufacturing process of the panel itself.

At operation 406, the rear surfaces of each trim piece (e.g., trim 104, 204, 304, etc.) may be sanded and/or otherwise planarized. This may produce trim pieces of a substantially uniform thickness such that when affixed to the panel, faces of each trim piece are substantially planar with one another. In some embodiments, the planarization of the trim pieces may be done using a belt sander and/or CNC tool, however other techniques are possible in various embodiments. Once both the trim pieces and the panel are planarized, an adhesive may be applied and the trim pieces may be positioned on the planarized regions of the panel at operation 408. In some embodiments, the adhesive may be a water-activated adhesive, although other adhesive types are usable in various embodiments. The trim and panel may be compressed together at operation 410, which may improve the contact and bond between the components. In some embodiments, one or more brads or other fasteners may be inserted through the panel and trim during the positioning of the trim pieces and/or compression step to help prevent the trim and panel from shifting laterally relative to one another prior to bonding the components.

In some embodiments, additional layers of material may be applied to a rear surface of the panel. For example, at operation 412 one or more layers of material may be affixed to the panel to form a frame (such as frames 106, 206, 306, etc.) that may reinforce the shed door. Each layer of the frame may be formed from one or more pieces of material. Pieces of frame within each layer may be planarized to a uniform thickness. The planarization may be performed using a CNC tool, belt sander, power sander/planer, and/or other technique. Each layer may be a same or different thickness from adjacent layers as long as each layer of the frame is individually uniform. The layers may be adhered to the rear surface of the panel and/or to one another using an adhesive. In some embodiments, the layers may be applied such that ends of frame pieces within each layer are staggered to create an overlapping pattern. This may ensure that there aren't any seams that extend through the entirety of the frame and may provide additional strength to the shed door. The frame and panel may be compressed together at operation 414, which may improve the contact and bond between the components. In some embodiments, one or more brads or other fasteners may be inserted through the panel and frame during the positioning of the frame pieces and/or compression step to help prevent the frame and panel from shifting laterally relative to one another prior to bonding the components.

In some embodiments, the frame may be preassembled (e.g., adhered and/or otherwise fastened together), with the preformed frame being adhered/compressed and/or otherwise affixed to the panel. In some such embodiments, the individual layers of the frame may not be planarized, but the final frame may be planarized. This may result in some thickness non-uniformity within individual frame layers while the frame as a whole has a uniform thickness. In other embodiments, the frame pieces may be assembled, adhered, and compressed at the same time as the frame is adhered and compressed against the panel. In some embodiments, additional layers, such as rear sheathing layers, may be applied to a rear of the panel and/or the frame. Such layers may be applied in a similar fashion as the frame and may include planarizing the rear sheathing, applying an adhesive, and compressing the rear frame, panel, and/or any other layers that are present.

In some embodiments, the compression of the various components of the shed door may be done in a single step. For example, adhesives may be applied to secure the trim and the frame to the panel and the entire shed door may be compressed at a single time. In other embodiments, multiple compression steps may be performed. For example, the panel and trim may be compressed and then the panel, trim, and frame may be compressed. As another example, the panel and frame may be compressed, then the trim may be added to the panel and the panel, trim, and frame may be compressed together. In some embodiments, the frame may be compressed a single time (e.g., once all layers are in place), while in other embodiments the frame may be compressed with the panel each time a new layer of frame is added. Numerous variations exist. Compression of the shed door may, in some embodiments, involve putting all or a portion of the shed door within a press and applying a pressure of between 8-12 PSI and/or a total of between 20,000 lb. and 30,000 lb. of force, although other pressures may be possible in various embodiments.

In some embodiments, compressing the shed door (or portion thereof) may involve forming a bow in the shed door. For example, one or more displacements and/or other templates may be inserted into and/or formed into the press that cause the compressed shed door to form a slight bow, with a top and/or bottom edge of the shed door curving away from a front surface of the shed door. The amount of bow may vary but may often be between about 0.125 inches and 0.5 inches from a top and/or bottom edge of the shed door to a center of the shed door.

The shed door may often include additional components, such as hinges, door handles, locks, ID tags, signs, and/or other features. Where one or more such components are affixed to a surface of the shed door, the process may include planarizing a portion of the surface of the door. As just one example, a front surface of the panel and/or the trim may be planarized to remove woodgrain and provide a planar surface to receive hinges for hanging the shed door. The planarized surfaces may be sized and shaped to match that of the hinges in some embodiments. The planarizing may be performed using a CNC tool in some embodiments. For example, the shed door may be positioned on a bed of the CNC tool such that a sanding and/or cutting tool of the CNC tool may planarize each hinge location to a consistent depth. This may ensure that the hinges are installed in a single plane to improve the alignment of the shed door once installed. In some embodiments, pilot holes and/or other holes (such as those for locks and/or door handles) may be drilled in the shed door. These holes may be formed on planarized surfaces (e.g., after CNC planarizing) in some embodiments. This may ensure that woodgrain texture is removed where the holes are being formed, which may improve the ability of the drill bit to stay properly aligned, as woodgrain texture has the potential to divert the drill bit at the beginning of drilling operations. Similarly, logos and/or other graphics may be formed in the panel and/or trim using such planarizing, drilling, and/or other machining techniques.

In some embodiments, the process may include running a router around a perimeter of the panel, trim, and/or frame to clean up any rough edges and/or to set the final size of the shed door. The router may be hand operated and/or may be part of a CNC tool.

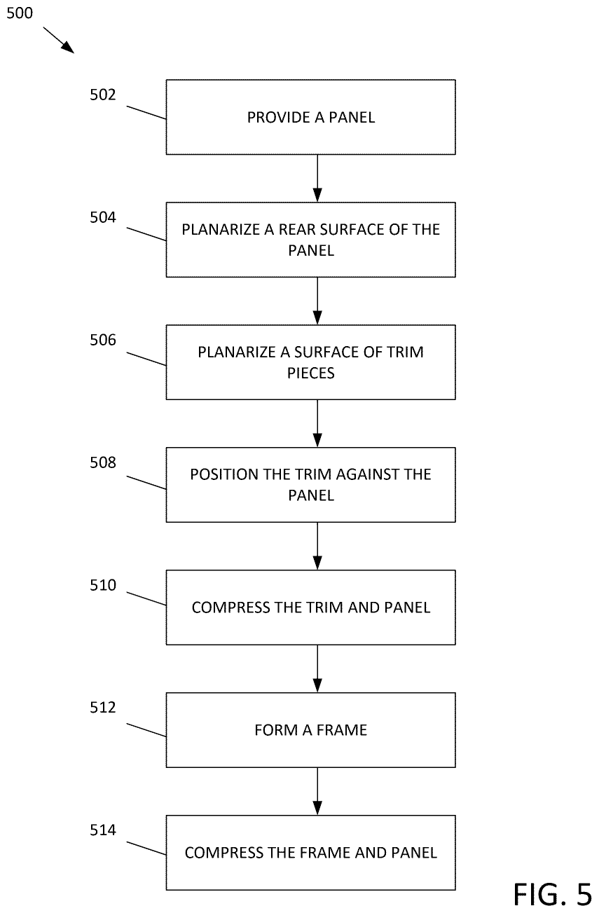

FIG. 5 is a flowchart illustrating a process 500 of manufacturing a shed door with trim on a front surface (such as described in relation to shed door 200). Process 500 may be used to manufacture shed doors 100, 200, and 300 described herein, as well as other shed doors. Process 500 may include additional steps and/or omit certain steps in various embodiments. Process 500 may include any feature of process 400 described above. Process 500 may begin at operation 502 by providing a panel of a desired size. Once the panel has been properly sized, portions of a rear surface of the panel where trim may be affixed may be sanded and/or otherwise planarized at operation 504. For example, a CNC tool may be used to planarize a border and/or other region about the rear surface of the panel to prepare a fully planar receiving surface for the trim.

At operation 506, the front and/or rear surfaces of each trim piece (e.g., trim 104, 204, 304, etc.) may be sanded and/or otherwise planarized. This may produce trim pieces of a substantially uniform thickness such that when affixed to the panel, faces of each trim piece are substantially planar with one another. Once both the trim pieces and the panel are planarized, an adhesive may be applied and the trim pieces may be positioned on the planarized regions of the panel at operation 508. The trim and panel may be compressed together at operation 510, which may improve the contact and bond between the components.

In some embodiments, additional layers of material may be applied to a rear surface of the panel and/or the trim. For example, at operation 512 one or more layers of material may be affixed to the rear surface of the trim to form a frame (such as frames 106, 206, 306, etc.) that may reinforce the shed door. Each layer of the frame may be formed from one or more pieces of material. Pieces of frame within each layer may be planarized to a uniform thickness. The frame, trim, and panel may be compressed together at operation 514, which may improve the contact and bond between the components.

In some embodiments, compressing the shed door (or portion thereof) may involve forming a bow in the shed door. For example, one or more displacements and/or other templates may be inserted into and/or formed into the press that cause the compressed shed door to form a slight bow, with a top and/or bottom edge of the shed door curving away from a front surface of the shed door. The amount of bow may vary but may often be between about 0.125 inches and 0.5 inches from a top and/or bottom edge of the shed door to a center of the shed door. The shed door may often include additional components, such as hinges, door handles, locks, ID tags, signs, and/or other features. Where one or more such components are affixed to a surface of the shed door, the process may include planarizing a portion of the surface of the door. In some embodiments, pilot holes and/or other holes (such as those for locks and/or door handles) may be drilled in the shed door. Similarly, logos and/or other graphics may be formed in the panel and/or trim using such planarizing, drilling, and/or other machining techniques. In some embodiments, the process may include running a router around a perimeter of the panel, trim, and/or frame to clean up any rough edges and/or to set the final size of the shed door.

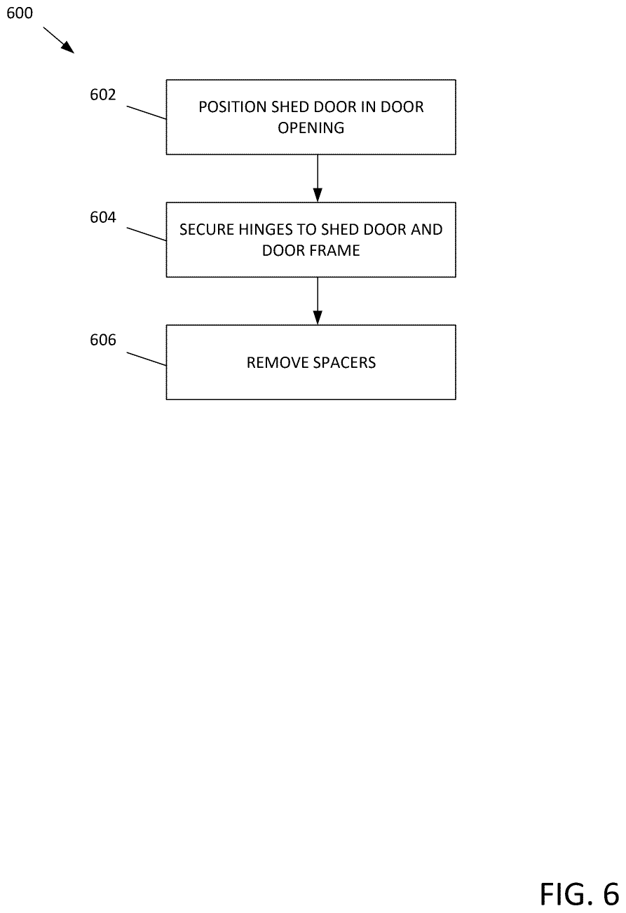

FIG. 6 is a flowchart illustrating a process 600 of installing a shed door. Process 600 may be used to install shed doors 100, 200, and 300 described herein, as well as other shed doors. It will be appreciated that while process 600 may be used to install shed doors 100, 200, and 300, the shed doors described herein may be installed using different processes in various embodiments. Process 600 may include additional steps and/or omit certain steps in various embodiments. Process 600 may begin at operation 602 by positioning the shed door within a door opening of a shed. The shed door may include a number of spacers, such as spacers 370, which may assist in properly aligning the shed door within the door opening. For example, the shed door may be positioned within the door opening such that spacers on each side of the shed door contact inner surfaces of the door frame. This may enable the spacers to set the desired position and spacing between the shed door and the door frame. In some embodiments, one or more spacers positioned on rear-facing surfaces of the shed door may also be provided to set a depth that the shed door sits within the door opening.

At operation 604, the hinges may be secured to the shed door and/or the door frame. Similarly, the door handle and/or locks may be secured to the shed door and/or the door frame. By securing the hinges, the shed door will be installed at the desired location that is determined by the spacers. Once the shed door is fixed in place, the shed door may be opened (or maintained in an open position) and the spacers may be removed at operation 606. For example, the spacers may be affixed to the door and/or door frame using an adhesive, small brad, and/or other removable coupling technique that enables the spaces to be removed without damaging the shed door or the door frame.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A shed door, comprising:
a panel;
a trim coupled with the panel;
a frame coupled with a rear surface of the panel, wherein:
portions of the panel contacting the trim are planarized and the trim is planarized such that exposed faces of the trim are coplanar when coupled with a face of the panel; and
the frame is planarized such that exposed faces of the frame are coplanar when coupled with the panel.

2. The shed door of claim 1, wherein:
the trim is coupled with a front face of the panel.

3. The shed door of claim 1, wherein:
the trim is coupled with the rear face of the panel.

4. The shed door of claim 3, wherein:
the trim is disposed between the frame and the panel.

5. The shed door of claim 1, further comprising:
a rear sheathing coupled with the frame.

6. The shed door of claim 1, wherein:
a front surface of one or both of the panel and the trim comprises one or more planarized regions for receiving hinges.

7. The shed door of claim 6, wherein:
the one or more planarized regions are sized and shaped to match interface portions of the hinges.

8. The shed door of claim 6, wherein:
the shed door is bowed with a top and bottom edge of the shed door extending away from a front surface of the panel.

9. A method of manufacturing a shed door, comprising:
providing a panel;
planarizing a portion of the panel;
applying trim to the portion of the panel;
planarizing a frame;
applying the frame to a rear surface of the panel; and
compressing the panel, the trim, and the frame with an adhesive to form the shed door.

10. The method of manufacturing a shed door of claim 9, wherein:
the trim is applied to a front surface of the panel.

11. The method of manufacturing a shed door of claim 9, wherein:
the trim is applied to the rear surface of the panel.

12. The method of manufacturing a shed door of claim 9, further comprising:
applying the adhesive between the trim and the panel; and
applying the adhesive between the frame and one or both of the trim and the panel.

13. The method of manufacturing a shed door of claim 9, further comprising:
planarizing one or more regions on one or both of the panel and the trim to form hinge-receiving locations.

14. The method of manufacturing a shed door of claim 12, further comprising:
drilling one or more holes in the one or more regions to accommodate one or more fasteners.

15. The method of manufacturing a shed door of claim 9, further comprising:
forming one or more holes for one or both of a door handle and a lock.

16. The method of manufacturing a shed door of claim 9, further comprising:
planarizing a portion of one or both of the trim and the panel to form a graphic.

17. The method of manufacturing a shed door of claim 9, further comprising:
applying one or more spacers to one or more edges of the shed door.
